(19) United States
(12) Patent Application Publication
(10) Pub. No.: US 2012/0122065 A1
(43) Pub. Date: May 17, 2012

(54) PERIODONTAL TRAINING

(75) Inventor: Richard John Snoad, Surrey (GB)

(73) Assignee: INFORMDENTAL LIMITED, Wedmore, Somerset (GB)

(21) Appl. No.: 13/264,921

(22) PCT Filed: Apr. 16, 2010
(86) PCT No.: PCT/GB10/00777

§ 371 Date: Jan. 31, 2012

(30) Foreign Application Priority Data
Apr. 16, 2009 (GB) 0906510.3

(51) Int. Cl. G09B 23/30

(52) U.S. Cl. 434/263

(57) ABSTRACT

The invention provides a periodontal training model (100) comprising a replica of a part of a jaw including gum (102) and associated teeth (104); and a plurality of holes (106) in the gum area for receiving, in use, a periodontal probe. The holes (106) are located at positions immediately adjacent the teeth (104).

The present invention relates to periodontal training models, in particular to a model for use in training of periodontal probing.

Periodontal probing is used in dentistry to assess the health of the teeth and the gums. In particular it is used by periodontists in assessing the health of the gums. Periodontal probing for gum health assessment involves the periodontist probing the gum tissue around the base of the teeth, with a periodontal probe, to assess the gum sulcus or pocket depth and attachment to the teeth and is used in diagnosing a wide variety of periodontal diseases. In use, proper use of the periodontal probe is necessary to maintain accuracy. The tip of the probe is placed or pressed lightly into the gingival sulcus, between a tooth and the surrounding tissue. The periodontal probe is kept parallel to the contours of the root of the tooth and is inserted down to the base of the pocket, which may vary in depth depending on the presence and extent of any gum disease present.

Generally this is a process which is learned over time by practice supervised by an experienced dental professional. This takes time and practice is difficult to master without direct supervision.

The present invention attempts to simplify and improve periodontal probing training.

According to the present invention there is provided a periodontal training model comprising: a replica of a part of a jaw including gum and associated teeth; and a plurality of holes in the gum area for receiving, in use, a periodontal probe.

Preferably the holes are located at positions immediately adjacent the teeth.

In a preferred arrangement the holes have a diameter adapted to closely receive a University of North Carolina (UNC) 15 mm pocket measuring probe, or similar. Preferably the holes have a predetermined depth, more preferably the holes are between 1 and 9 mm in depth. Preferably the holes have a predetermined angle, more preferably the holes enter the gum area at set angles between 10 and 40 degrees, preferably at angles of 15 and 35 degrees to the long axis of the teeth.

In the above manner a periodontal student, student dentist or student dental hygienist can use the model to practice periodontal probing. The diameter of the holes is chosen such that standard periodontal probes will be able to enter the holes but will have to enter the holes substantially aligned with the axis of the hole, thus ensuring that the student enters the probe at the angle of the hole. The depths and angles of the holes are chosen such that the student becomes accustomed to moving the periodontal probe at the inclinations and in the increments necessary for use in performing periodontal probing on a patient. In this manner the basic skills of periodontal probing can be taught prior to the student performing such an analysis on a patient. Furthermore the model enables the student to become accustomed to the feeling of different periodontal pockets that they may encounter when performing a periodontal probing examination on a patient.

In a preferred arrangement each tooth of the model has an equal number of holes adjacent its base. Preferably each tooth has three holes adjacent its base on its exterior surface and each tooth has three holes adjacent its base on its interior surface. Preferably one of said three holes is located substantially at the centre of the base of each tooth and the other two holes are substantially located at either end of the base of each tooth.

In this manner the student can become accustomed to the manual dexterity associated with periodontal probing in common positions.

In one preferred arrangement the model is made by printing a photopolymer in layers, e.g. by layer by layer UV curing, laser sintering or similar. In this way the required accuracy of the probing bores is simply obtained.

In an alternative preferred arrangement the gum and teeth of the model are made of different materials, thereby giving a more life like feel to the model.

Optionally, the model may further comprise a second periodontal training model, the same as the first periodontal training model, arranged in opposing orientation to the first periodontal training model so as to replicate both the maxilliary and the mandibular jaws.

In this way the student can become accustomed to both the upper and lower buccal and palatal probing, particularly in relation to upper and lower palatal/lingual probing, the student can become accustomed to probing the interior gum with the probe inserted between the upper and lower jaw which can require considerable manual dexterity.

The size and shape of the model and the holes may be varied to simulate adult male and female jaws and also children's jaws.

Embodiments of the invention will now be described, by way of example only, with reference to the accompanying drawings in which:

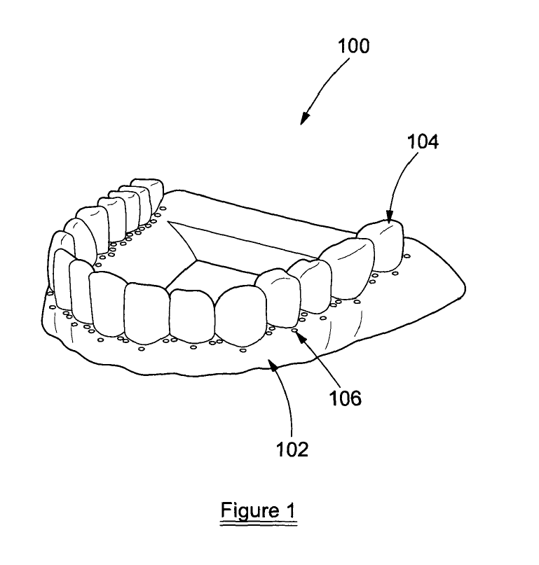

FIG. 1 is a perspective view of a mandibular orientated periodontal training model according to the invention;

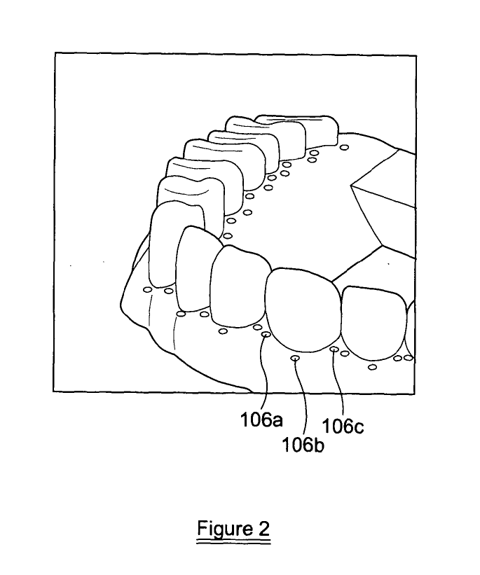

FIG. 2 is a close up of a part of the model of FIG. 1; and

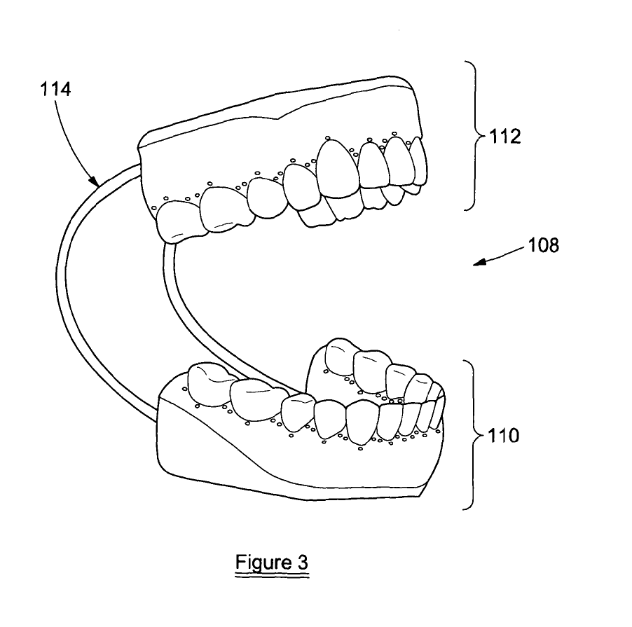

FIG. 3 is a perspective view of a maxilliary orientated and mandibular orientated periodontal training model.

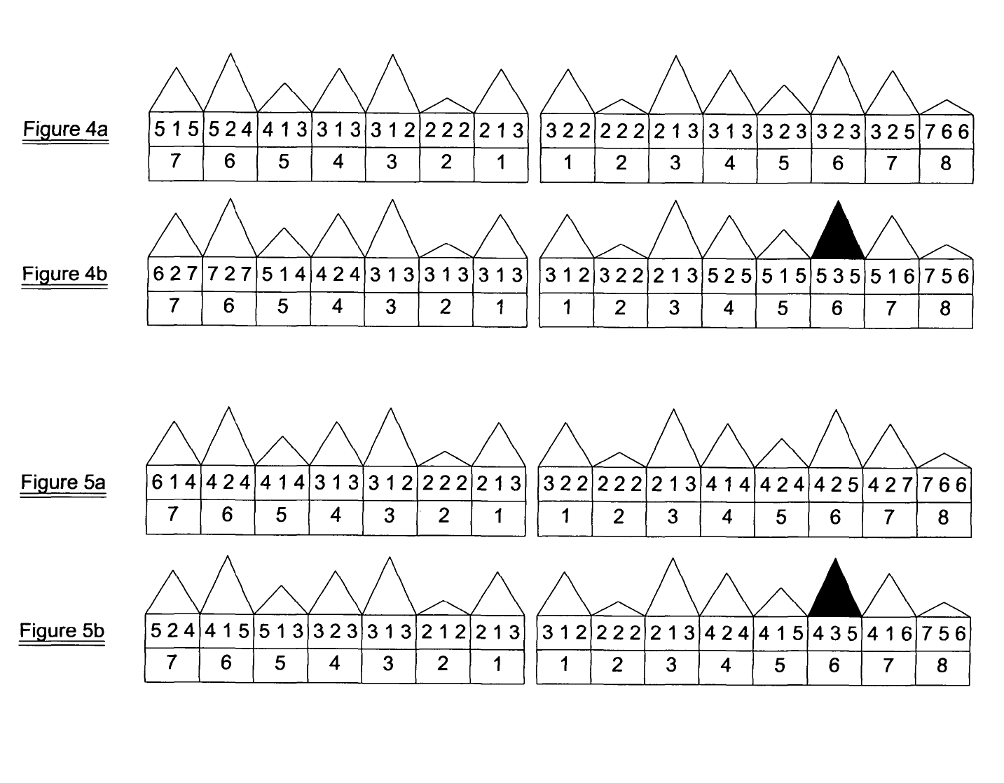

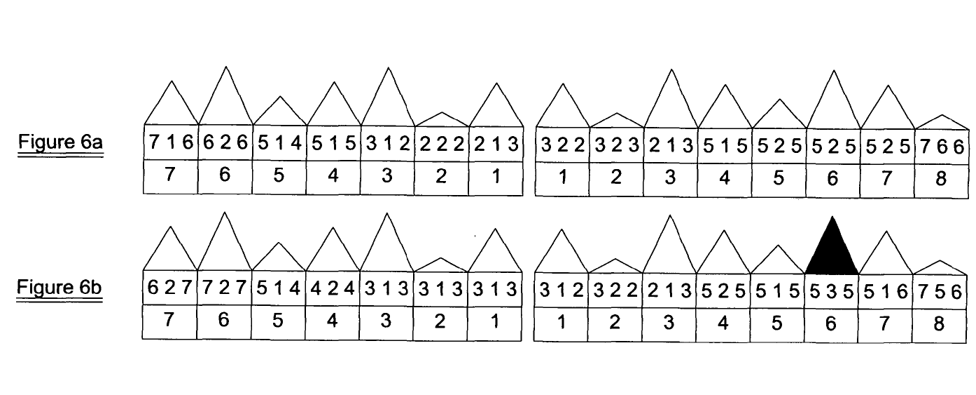

FIGS. 4 to 6 are charts of probing depths and angles for three different models.

Referring to the FIGS. 1 and 2 a periodontal training model 100 is shown. The model 100 comprises a gum section 102 and a plurality of teeth 104. The gum and teeth may be moulded separately or are preferably all formed as part of a single moulding process. The model has a plurality of bores 106 therein substantially at the join line between the gum 102 and teeth 104. Three bores 106a 106b and 106c are associated with each of the buccal and the palatal/lingual sides of each tooth and are located one 106b substantially in the middle of the tooth/gum line and one 106a, 106c at either end thereof. The bore diameters are sized to accurately receive a UNC15, or similar, probe and vary in depth between 1 and 9 mm. The bores 106 are angled relative the long axis of the tooth at an angle of 15 or 35 degrees. The bores at the back of the last molars in the arch, between the molars, between the molars and pre-molars, between the pre-molars and at the front of the first premolars, are angled at 35 degrees to the long-axes of the teeth. The bores for all other probing sites are angled at 15 degrees to the long axis of the teeth.

In use a periodontal student can use the model 100 to practice periodontal probing by using a standard periodontal probe (not shown) and inserting the end of the probe into the holes. In this manner the student can become accustomed to the feeling of the depth and angle which the probe is inserted for the different teeth. This is important as, to probe accurately, the probe needs to be kept substantially parallel with the root of the tooth and probing to excessive depth can cause unnecessary pain to the patient.

FIGS. 1 and 2 show a model having a mandibular orientation but the model could equally be aligned in a maxillary orientation.

Referring to FIG. 3 a periodontal training model 108 is shown comprising a mandibular model 110 and a maxilliary 112 model, joined together by resilient joining means 114. When using such a model to proactive periodontal training the student is subjected to a more realistic training model wherein the palatal probing holes must be accessed by passing the probe through the opening between the mandibular and maxilliary models. The resilient joining means are preferably partially deformable such that the opening between said mandibular and maxilliary models can be altered.

Referring to FIGS. 4a to 6b probing depths and angles are shown for a palatal (FIGS. 4a, 5a and 6a) and buccal (4b, 5b and 6b) bores of three different training models. The lower row of figures in each diagram indicates the tooth, numbers 1 being central incisors and the numbers increasing to the left and right as viewed from the front, and the upper row of figures in each diagram indicates the depth in mm and the angle at which the holes are provided for each tooth. The figures in bold are bores provided at an angle of 35 degrees to the long axis of the tooth and the remaining bores are provided at an angle of 15 degrees to the long axis of the tooth. A buccal furcation is provided on the tooth indicated in black.

Preferably a set of models having the different angles and depths of bores is provided such that each model can be used in an upper or lower jaw orientation to provide a variety or different probing depths at different locations for the student to train with. In use the measured depth can be verified against the known values of bore depth to assess the students adeptness at measuring pocket depth around teeth.

1. A periodontal training model comprising:
a replica of a part of a jaw including gum and associated teeth; and
a plurality of discreet holes in the gum area for receiving, in use, a periodontal probe.

2. A periodontal training model according to claim 1 wherein the holes are located at positions immediately adjacent the teeth.

3. A periodontal training model according to claim 1 or claim 2 wherein the hole diameters are dimensioned to closely receive a University of North Carolina (UNC) 15 probe, or similar.

4. A periodontal training model according to claim 1 wherein the holes have a predetermined depth.

5. A periodontal training model according to claim 4 wherein the holes are between 1 and 9 mm in depth.

6. A periodontal training model according to claim 1 wherein the holes have a predetermined angle.

7. A periodontal training model according to claim 6 wherein the holes enter the gum area at an angle in the range of 10 to 40 degrees to the long axis of the teeth.

8. A periodontal training model according to claim 7 wherein the holes enter the gum area at angles of 15 and 35 degrees to the long axis of the teeth

9. A periodontal training model according to claim 1 wherein each tooth of the model has an equal number of holes adjacent its base.

10. A periodontal training model according to claim 9 wherein each tooth has three holes adjacent its base on its exterior surface.

11. A periodontal training model according to claim 9 wherein each tooth has three holes adjacent its base on its interior surface.

12. A periodontal training model according to claim 10 wherein one of said three holes is located substantially at the centre of the base of each tooth and the other two holes are substantially located at either end of the base of each tooth.

13. A periodontal training model according to claim 1 wherein the model is made of a printed or sintered photopolymer.

14. A periodontal training model according to claim 1 wherein the gum and teeth of the model are made of different materials.

15. A periodontal training model according to claim 1 having a buccal furcation on at least one of the teeth.

16. A periodontal training model according to claim 1, further comprising a second periodontal training model, the same as the first periodontal training model, arranged in opposing orientation to the first periodontal training model so as to replicate an upper and lower jaw.

17. A periodontal training set comprising a plurality of periodontal training models according to claim 1 wherein each model has different sets of bore depths and/or angles.

18. A periodontal training set according to claim 17 comprising three training models.

19. A periodontal training set according to claim 18 wherein the bore depths and angles are as detailed with reference to FIGS. 4a to 6b.

20. (canceled)

21. A periodontal training model according to claim 11 wherein one of said three holes is located substantially at the centre of the base of each tooth and the other two holes are substantially located at either end of the base of each tooth.
